(19) United States
(12) Patent Application Publication
(10) Pub. No.: US 2011/0011909 A1
(43) Pub. Date: Jan. 20, 2011

(54) Bicycle Carrier for a Wheeled Vehicle

(76) Inventor: Yao-Huang Liu, Yongkang City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/503,106

(22) Filed: Jul. 15, 2009

(51) Int. Cl. B60R 9/10

(52) U.S. Cl. 224/501; 224/519; 224/523; 224/533; 224/502

(57) ABSTRACT

A bicycle carrier includes a mounting base, a main frame mounted on and movable relative to the mounting base, two limit pins each mounted between the main frame and the mounting and a positioning pin mounted on the main frame and detachably locked onto the mounting base. The main frame includes a main tube movably mounted on the mounting base, a plurality of support tubes mounted on the main tube and a plurality of adjusting tubes adjustably mounted on the support tubes. Thus, when the mounting base and the main frame are unlocked from the positioning pin, the main frame is pulled outwardly relative to the mounting base and is disposed at an inclined state, so that the bicycles placed on the main frame are spaced from the trunk of a car to facilitate a user opening the trunk.

### BACKGROUND OF THE INVENTION

1. Field of the Invention

The present invention relates to a carrier and, more particularly, to a bicycle carrier for a wheeled vehicle, such as a car and the like.

2. Description of the Related Art

A conventional bicycle carrier for a wheeled vehicle in accordance with the prior art shown in FIG. 10 comprises a substantially inverted U-shaped first support bracket 2, a substantially U-shaped second support bracket 3 connected with the first support bracket 2, two first protective jackets 4 mounted on the first support bracket 2, a plurality of first fixing straps 6 mounted on the first support bracket 2 by a plurality of first fasteners 5, two second protective jackets 7 mounted on the second support bracket 3, two second fixing straps 60 mounted on the second support bracket 3 by two second fasteners 9, and two rubber sleeves 8 mounted on the second support bracket 3. The second support bracket 3 is perpendicular to the first support bracket 2. When in use, when the bicycle carrier is mounted a car, the first support bracket 2 is attached to the rear portion of the car by the first fixing straps 6, and the second support bracket 3 is attached to the rear portion of the car by the second fixing straps 60. However, the trunk of the car is stopped by the bicycle carrier so that the trunk cannot be opened, thereby greatly causing inconvenience to the user. In addition, the bicycle carrier is used to carry one or two bicycles, thereby limit the versatility of the bicycle carrier. Further, the size of the bicycle carrier cannot be adjusted to fit the length of the bicycle so that the bicycle is not supported by the bicycle carrier exactly and stably.

### BRIEF SUMMARY OF THE INVENTION

In accordance with the present invention, there is provided a bicycle carrier, comprising a mounting base, a main frame mounted on the mounting base and movable relative to the mounting base, two limit pins each mounted between the main frame and the mounting base to limit the main frame onto the mounting base and a positioning pin mounted on the main frame and detachably locked onto the mounting base to releasably lock the main frame onto the mounting base. The main frame includes a main tube movably mounted on the mounting base, a plurality of support tubes mounted on the main tube and a plurality of adjusting tubes adjustably mounted on the support tubes.

The primary objective of the present invention is to provide a bicycle carrier for a wheeled vehicle, wherein when the mounting base and the main tube are unlocked from the positioning pin, the main frame is pulled outwardly relative to the mounting base and is disposed at an inclined state, so that the bicycles placed on the main frame are spaced from the trunk of the car so as to facilitate a user opening the trunk of the car without incurring interference.

Another objective of the present invention is to provide a bicycle carrier for a wheeled vehicle, wherein the relative position between each of the support tubes and each of the adjusting tubes can be adjusted properly to fit the length of each of the bicycles so that each of the bicycles is placed on the main frame exactly and stably.

A further objective of the present invention is to provide a bicycle carrier for a wheeled vehicle, wherein the support tubes of the main frame are parallel with each other so that the bicycles placed on the support tubes are arranged regularly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a bicycle carrier in accordance with the preferred embodiment of the present invention.

FIG. 2 is a locally enlarged view of the bicycle carrier taken along a circle “A” as shown in FIG. 1.

FIG. 2A is a side cross-sectional view of the bicycle carrier as shown in FIG. 2.

FIG. 3 is an exploded perspective view of the bicycle carrier as shown in FIG. 2.

FIG. 4 is a locally enlarged view of the bicycle carrier taken along a circle “B” as shown in FIG. 1.

FIG. 5 is an exploded perspective view of the bicycle carrier as shown in FIG. 4.

FIG. 6 is a side cross-sectional view of the bicycle carrier as shown in FIG. 4.

FIG. 7 is a perspective view showing the bicycle carrier for placing a plurality of bicycles.

FIG. 8 is a schematic operational view of the bicycle carrier as shown in FIG. 2 in use.

FIG. 9 is a perspective view showing the bicycle carrier for a car.

FIG. 10 is a perspective view of a conventional bicycle carrier for a car in accordance with the prior art.

### DETAILED DESCRIPTION OF THE INVENTION

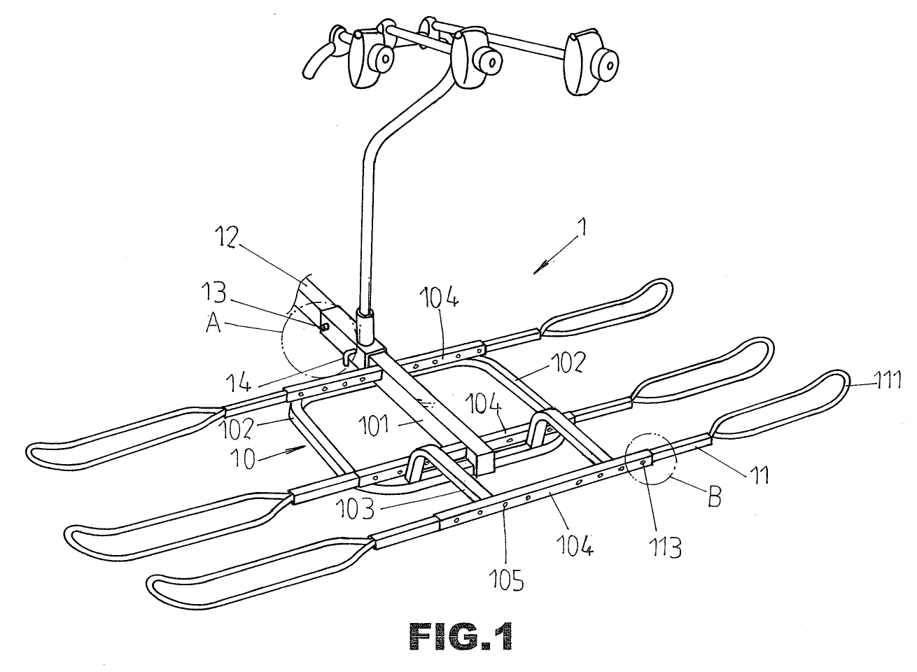

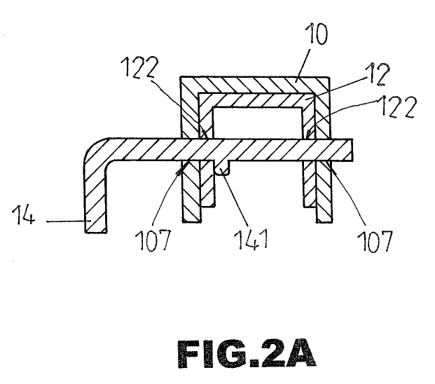

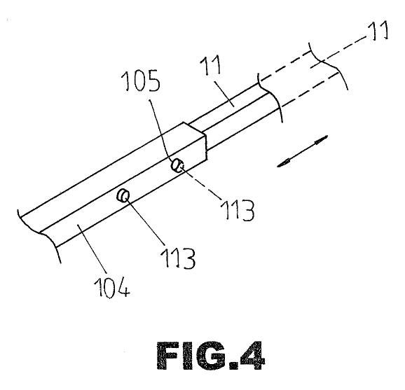

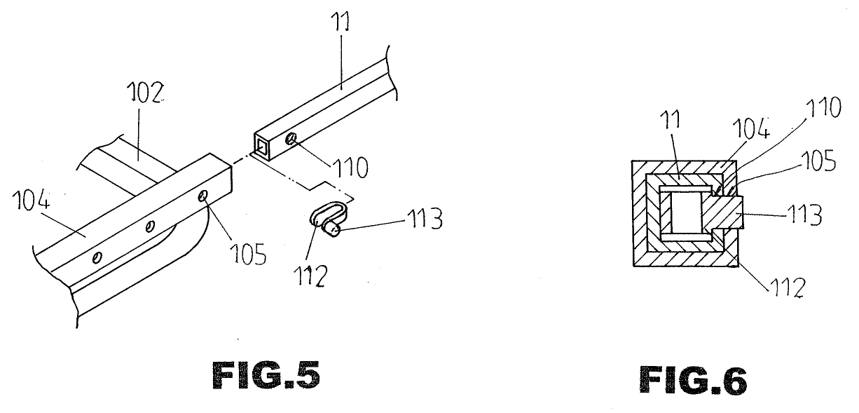

Referring to the drawings and initially to FIGS. 1-6, a bicycle carrier 1 for a wheeled vehicle in accordance with the preferred embodiment of the present invention comprises a mounting base 12, a main frame 10 mounted on the mounting base 12 and movable relative to the mounting base 12, two limit pins 13 each mounted between the main frame 10 and the mounting base 12 to limit the main frame 10 onto the mounting base 12, and a positioning pin 14 mounted on the main frame 10 and detachably locked onto the mounting base 12 to releasably lock the main frame 10 onto the mounting base 12.

The mounting base 12 is an elongate hollow post and has a substantially square cross-sectional profile. The mounting base 12 has an end portion having a top provided with an oblique guide face 121. The mounting base 12 is provided with two elongate guide slots 122 formed on two opposite sidewalls of the mounting base 12 respectively. Each of the two guide slots 122 of the mounting base 12 has an end portion provided with an oblique guide groove 124 which is parallel with the oblique guide face 121 of the mounting base 12.

The main frame 10 includes a main tube 101 movably mounted on the mounting base 12, a plurality of support tubes 104 mounted on the main tube 101, and a plurality of adjusting tubes 11 adjustably mounted on the support tubes 104.

The main tube 101 of the main frame 10 is provided with two through holes 106 and two positioning holes 107 formed on two opposite sidewalls of the main tube 101 respectively.

Each of the two limit pins 13 is mounted in a respective one of the two through holes 106 of the main tube 101 and is movable in a respective one of the two guide slots 122 of the mounting base 12. Each of the two limit pins 13 is movable into the oblique guide groove 124 of the respective guide slot 122. The main tube 101 of the main frame 10 is pivoted downward relative to the mounting base 12 in an oblique manner by guidance of the oblique guide face 121 of the mounting base 12 when each of the two limit pins 13 is movable into the oblique guide groove 124 of the respective guide slot 122.

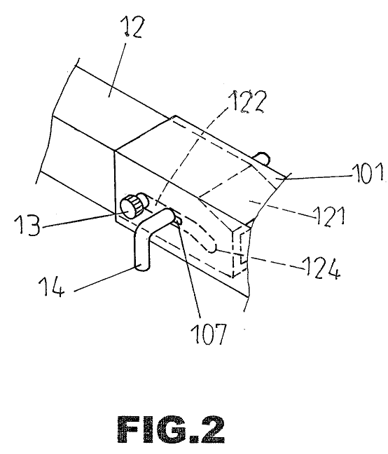

The positioning pin 14 has a substantially L-shaped profile. The positioning pin 14 extends through the two positioning holes 107 of the main tube 101 and through the two guide slots 122 of the mounting base 12. The positioning pin 14 has a side provided with a positioning boss 141 which extends through one the two positioning holes 107 of the main tube 101 and one of the two guide slots 122 of the mounting base 12 and is movable to press a wall of one of the two guide slots 122 as shown in FIG. 2A by rotation of the positioning pin 14 relative to the main tube 101 and the mounting base 12.

Each of the support tubes 104 of the main frame 10 co-operates with two adjusting tubes 11. The support tubes 104 of the main frame 10 are parallel with each other and are perpendicular to the main tube 101. The support tubes 104 of the main frame 10 are attached to the main tube 101 by a first connecting bracket 102 and two second connecting brackets 103. Each of the two second connecting brackets 103 has a height greater than that of the first connecting bracket 102.

Each of the adjusting tubes 11 of the main frame 10 has a first end adjustably mounted on any one of two opposite ends of each of the support tubes 104 by an elastic knob 112 and a second end provided with a placement rack 111. The first end of each of the adjusting tubes 11 has a side provided with a through bore 110. Each of the two opposite ends of each of the support tubes 104 has a side provided with a plurality of locking bores 105. The elastic knob 112 has a substantially U-shaped profile. The elastic knob 112 is received in each of the adjusting tubes 11 and has a side provided with a protruding locking stub 113 that is movably mounted in the through bore 110 of each of the adjusting tubes 11 and is detachably locked in any one of the locking bores 105 of each of the support tubes 104.

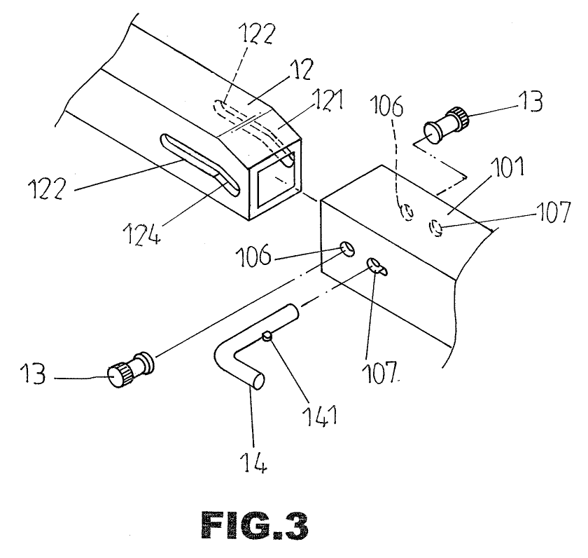

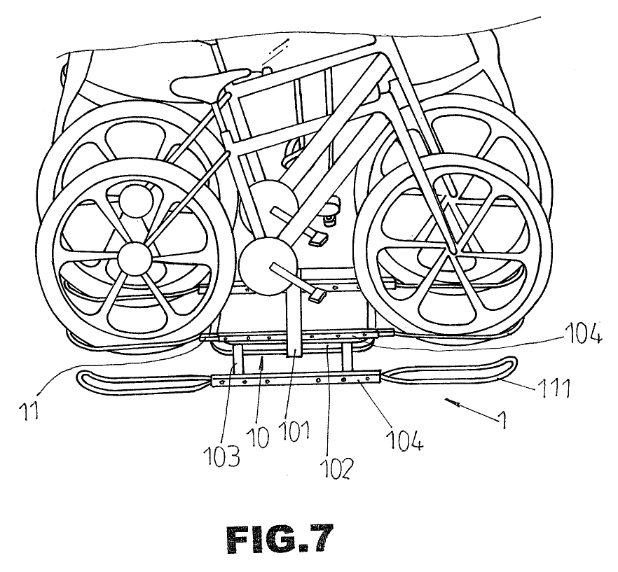

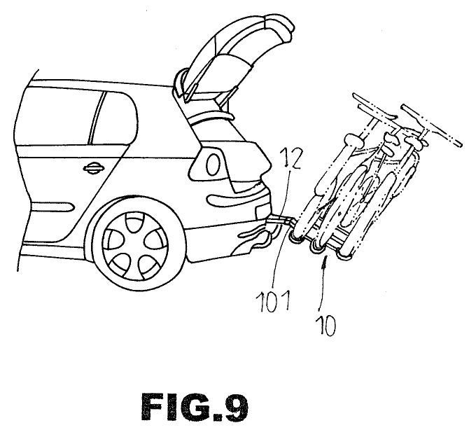

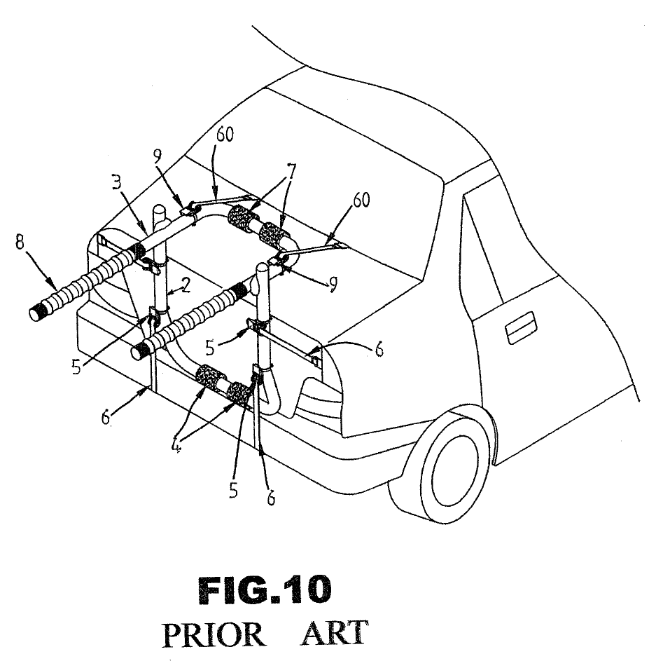

In operation, referring to FIGS. 7-9 with reference to FIGS. 1-6, the mounting base 12 is mounted on a rear portion of a car as shown in FIG. 9 to attach the bicycle carrier to the car. In such a manner, each of the support tubes 104 of the main frame 10 co-operates with two adjusting tubes 11 as shown in FIG. 1 so that the support tubes 104 of the main frame 10 are used to support a plurality of bicycles as shown in FIG. 7. At this time, the locking stub 113 of the elastic knob 112 is detachably locked in any one of the locking bores 105 of each of the support tubes 104 to adjust the relative position between each of the support tubes 104 and each of the adjusting tubes 11 as shown in FIG. 4 so as to fit the length of each of the bicycles.

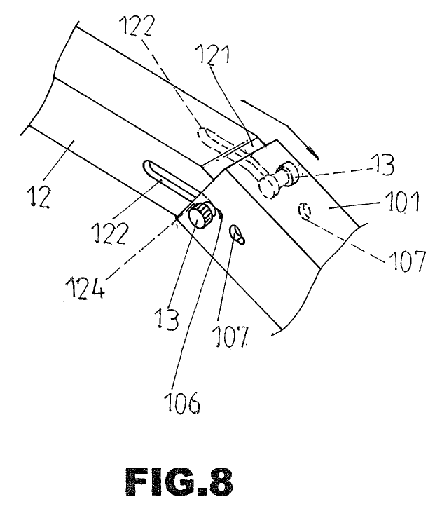

On the other hand, when the positioning pin 14 is rotated relative to the main tube 101, the positioning boss 141 of the positioning pin 14 is moved to detach from the wall of one of the two guide slots 122 of the mounting base 12 and is moved to align with one the two positioning holes 107 of the main tube 101 so that the positioning pin 14 can be detached from the mounting base 12 and the main tube 101. Thus, the mounting base 12 and the main tube 101 are unlocked from the positioning pin 14 so that the main tube 101 of the main frame 10 can be moved relative to the mounting base 12. In such a manner, when the main tube 101 of the main frame 10 is moved outwardly relative to the mounting base 12, the main tube 101 of the main frame 10 is pivoted and inclined downward relative to the mounting base 12 by guidance of the oblique guide face 121 of the mounting base 12 as shown in FIG. 8, so that the main frame 10 is disposed at an inclined state as shown in FIG. 9, and the bicycles are spaced from the trunk of the car so as to facilitate a user opening the trunk of the car.

Accordingly, when the mounting base 12 and the main tube 101 are unlocked from the positioning pin 14, the main frame 10 is pulled outwardly relative to the mounting base 12 and is disposed at an inclined state, so that the bicycles placed on the main frame 10 are spaced from the trunk of the car so as to facilitate a user opening the trunk of the car without incurring interference. In addition, the relative position between each of the support tubes 104 and each of the adjusting tubes 11 can be adjusted properly to fit the length of each of the bicycles so that each of the bicycles is placed on the main frame 10 exactly and stably. Further, the support tubes 104 of the main frame 10 are parallel with each other so that the bicycles placed on the support tubes 104 are arranged regularly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A bicycle carrier, comprising:
a mounting base;
a main frame mounted on the mounting base and movable relative to the mounting base;
two limit pins each mounted between the main frame and the mounting base to limit the main frame onto the mounting base;
a positioning pin mounted on the main frame and detachably locked onto the mounting base to releasably lock the main frame onto the mounting base.

2. The bicycle carrier of claim 1, wherein the main frame includes:
a main tube movably mounted on the mounting base;
a plurality of support tubes mounted on the main tube;
a plurality of adjusting tubes adjustably mounted on the support tubes.

3. The bicycle carrier of claim 2, wherein
the mounting base is provided with two elongate guide slots formed on two opposite sidewalls of the mounting base respectively;
the main tube of the main frame is provided with two through holes and two positioning holes formed on two opposite sidewalls of the main tube respectively;
each of the two limit pins is mounted in a respective one of the two through holes of the main tube and is movable in a respective one of the two guide slots of the mounting base;
the positioning pin extends through the two positioning holes of the main tube and through the two guide slots of the mounting base.

4. The bicycle carrier of claim 1, wherein the positioning pin has a substantially L-shaped profile.

5. The bicycle carrier of claim 3, wherein the positioning pin has a side provided with a positioning boss which extends through one the two positioning holes of the main tube and one of the two guide slots of the mounting base and is movable to press a wall of one of the two guide slots by rotation of the positioning pin relative to the main tube and the mounting base.

6. The bicycle carrier of claim 3, wherein the mounting base has an end portion having a top provided with an oblique guide face.

7. The bicycle carrier of claim 6, wherein each of the two guide slots of the mounting base has an end portion provided with an oblique guide groove which is parallel with the oblique guide face of the mounting base.

8. The bicycle carrier of claim 7, wherein each of the two limit pins is movable into the oblique guide groove of the respective guide slot.

9. The bicycle carrier of claim 8, wherein the main tube of the main frame is pivoted downward relative to the mounting base in an oblique manner by guidance of the oblique guide face of the mounting base when each of the two limit pins is movable into the oblique guide groove of the respective guide slot.

10. The bicycle carrier of claim 2, wherein each of the support tubes of the main frame co-operates with two adjusting tubes.

11. The bicycle carrier of claim 2, wherein the support tubes of the main frame are attached to the main tube by a first connecting bracket and two second connecting brackets.

12. The bicycle carrier of claim 11, wherein each of the two second connecting brackets has a height greater than that of the first connecting bracket.

13. The bicycle carrier of claim 12, wherein each of the adjusting tubes of the main frame has a first end adjustably mounted on any one of two opposite ends of each of the support tubes by an elastic knob.

14. The bicycle carrier of claim 13, wherein each of the adjusting tubes of the main frame has a second end provided with a placement rack.

15. The bicycle carrier of claim 13, wherein
the first end of each of the adjusting tubes has a side provided with a through bore;
each of the two opposite ends of each of the support tubes has a side provided with a plurality of locking bores;
the elastic knob is received in each of the adjusting tubes and has a side provided with a protruding locking stub that is movably mounted in the through bore of each of the adjusting tubes and is detachably locked in any one of the locking bores of each of the support tubes.

16. The bicycle carrier of claim 13, wherein the elastic knob has a substantially U-shaped profile.

17. The bicycle carrier of claim 2, wherein the support tubes of the main frame are parallel with each other.

18. The bicycle carrier of claim 2, wherein the support tubes of the main frame are perpendicular to the main tube.
